(19) United States
(12) Patent Application Publication
(10) Pub. No.: US 2011/0210600 A1
(43) Pub. Date: Sep. 1, 2011

(54) WHEEL RIM DECORATIVE LAMP

(75) Inventor: YUNG-FA LIN, TAIPEI COUNTY (TW)

(73) Assignees: JUST AUTO ACCESSORIES CO., LTD., TAIPEI HSIEN (TW); TOYOTA TSUSHO (TAIWAN) CO., LTD., TAIPEI (TW); CARMAX CO., LTD., TAOYUAN COUNTY (TW)

(21) Appl. No.: 12/714,653

(22) Filed: Mar. 1, 2010

(51) Int. Cl. B60B 7/04; B60Q 1/26

(52) U.S. Cl. 301/37.108; 362/500

(57) ABSTRACT

A wheel rim decorative lamp for mounting on the wheel rim of a vehicle comprises a motor assembly, a circuit board, a plurality of light emitting diodes, a light transmissive shell and a cover. The motor assembly includes a motor and a counterweight block, The motor has a rotating shaft and a housing. The light emitting diodes are disposed on one side of the circuit board. The light transmissive shell is disposed on one side of the circuit board. The cover disposed on one side of the circuit board is pivotally connected to the rotating shaft and drives the rotating shaft to relatively rotate with the housing, so as to generate electricity to actuate the light emitting diodes. Hence, the present invention improves safety and provides aesthetic feeling.

### BACKGROUND OF THE INVENTION

1. Field of the Invention

The present invention relates to a wheel rim decorative lamp, and more particularly to a wheel rim decorative lamp capable of automatically emitting light when the wheel rotates.

2. Description of the Related Art

When the sun just went down, drivers usually do not turn on headlights or corner lights of the vehicle because they still have clear view. In this time, serious accidents will not happen when driving on the urban road because the drivers pay more attentions to incoming vehicles and pedestrians. But at the same time, when the drivers drive vehicles on the rugged and uneven mountain path without turning on the headlights or corner lights, owing to a dusky lighting condition and lack of enough view, the traffic accidents will easily happen,

Besides, the corner lights are mounted on the four corners of the vehicle, though it creates the motion light effect when the vehicle moves, the corner lights only provide static alarming in regard to relative moving speed, thus provide less warning effect for incoming vehicles. Moreover, because the corner lights are disposed on the position partial to front or rear end of, the vehicle, it can not provide any warning effect at the lateral side of the vehicle.

Moreover, although a brake light disposed on the rear end of the vehicle can be used for alarming vehicles from the rear side, the brake light still can not provide any warning effect when driving.

Thus, it is important to provide a lamp disposed on the lateral of the vehicle, so as to improve safety and provide aesthetic feeling at the same time.

### SUMMARY OF THE INVENTION

The primary object of the present invention is to provide a wheel rim decorative lamp capable of emitting light automatically when the wheel rotates, so as to improve safety and provide aesthetic feeling at the same time.

To achieve the foregoing object, a wheel rim decorative lamp of the present invention comprises a motor assembly, a circuit board, a plurality of light emitting diodes, a light transmissive shell and a cover. The motor assembly includes a motor and a counterweight block. The motor has a rotating shaft and a housing. The housing is disposed on the outer side of the rotating shaft. The counterweight block is disposed on the outer side of the motor. The circuit board is disposed on one side of the motor assembly. The light emitting diodes are disposed on one side of the circuit board. The light transmissive shell is disposed on one side of the circuit board. The cover is disposed on the side of the circuit board and pivotally connected to the rotating shaft. The cover drives the rotating shaft to rotate relatively with the housing, so as to generate electricity to actuate the light emitting diodes to emit lights.

The wheel rim decorative lamp further comprises a collar disposed on the inner side of the cover for contacting against the cover.

The motor assembly further comprises a first plate and a second plate. The first plate is disposed on one side of the motor, the second plate is disposed on the other side of the motor, and the counterweight block is disposed on one side of the second plate.

Furthermore, the wheel rim decorative lamp further comprises a plurality of grooves provided on the inner side of the cover, and the collar is inserted into the grooves.

### BRIEF DESCRIPTION OF THE DRAWINGS

FIG. 1 is a schematic view of a wheel rim decorative lamp assembled with a wheel rim according to an embodiment of the present invention.

FIG. 2 is an exploded view of a wheel rim decorative lamp according to an embodiment of the present invention.

FIG. 3 is an assembly view of a wheel rim decorative lamp according to an embodiment of the present invention.

FIG. 4 is an exploded view of a motor assembly of a wheel rim decorative lamp according to an embodiment of the present invention.

FIG. 5 is a first actuating view of a wheel rim decorative lamp according to an embodiment of the present invention.

FIG. 6 is a second actuating view of a wheel rim decorative lamp according to an embodiment of the present invention.

### DETAILED DESCRIPTION OF THE PREFERRED EMBODIMENTS

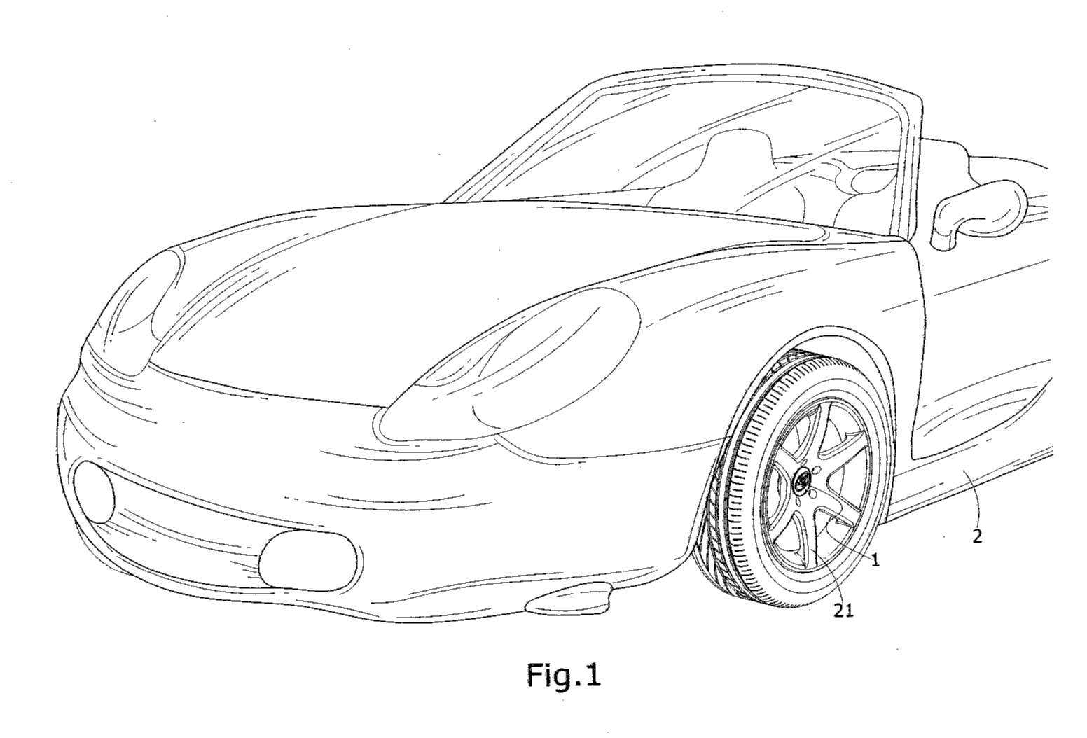

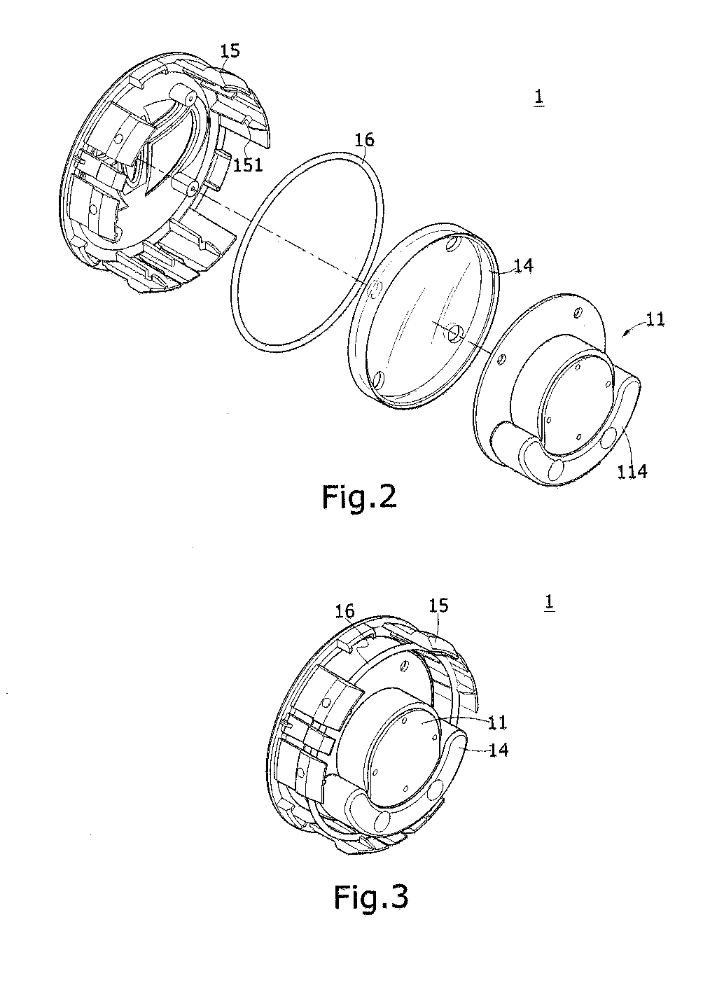

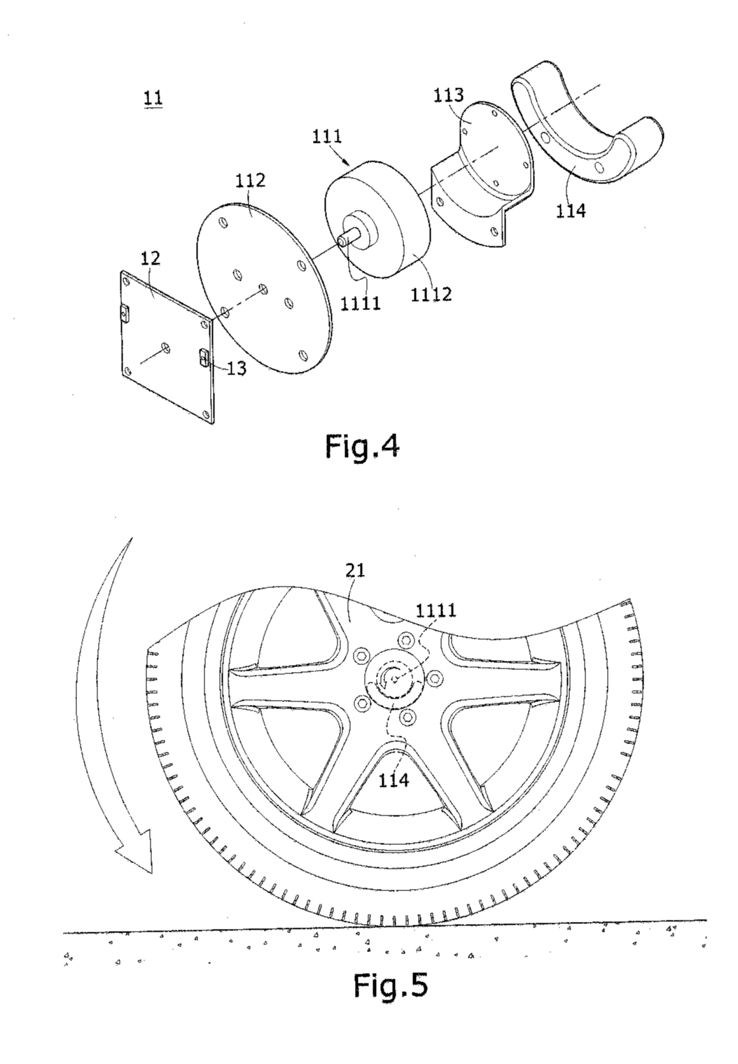

The contents of the present invention will become more apparent from the following description when taken in conjunction with the drawings. is Refers to FIGS. 1, 2, 3 and 4, which are schematic view, exploded view, assembled view and exploded view of a motor assembly according to the present invention respectively. In these figures, a wheel rim decorative lamp 1 of a preferred embodiment of the present invention is assembled with a wheel rim 21 of a vehicle 2 and comprises a motor assembly 11, a circuit board 12, a plurality of light emitting diodes 13, a light transmissive shell 14, a cover 15 and a collar 16.

The motor assembly 11 includes a motor 111, a first plate 112, a second plate 113 and a counterweight block 114. The first plate 112 can be shaped as a circle and made of stainless steel. The first plate 112 is disposed on one side of the motor 111. The second plate 113 can be made of stainless steel, and one end of the second plate 113 is shaped corresponding to the motor 113 and disposed on the other side of the motor 111. The counterweight block 114 can be shaped as a curve and is disposed on one side of the second plate 113. The motor 111 has a rotating shaft 1111 and a housing 1112. The rotating shaft 111 connects to a rotor (not shown in the figure) consisting of winding coils. A stator (not shown in the figure) consisting of magnet is provided at inner side of the housing 1112 which is disposed on the periphery of the rotating shaft 1111. The first plate 112 and the second plate 113 can be fastened to each other by a plurality of screws(not shown), and the second plate 113 and the counterweight block 114 can be fastened to each other by a plurality of screws(not shown), also. Moreover, the counterweight block 114 is used for providing the eccentric loads, so as to prevent the housing 1112 rotate with the wheel rim 21.

The circuit board 12 is disposed on one side of the motor assembly 11 and can be fastened to the motor assembly 11 by a plurality of screws (not shown). Besides, the circuit board 12 is electrically connected to the motor assembly 11.

The light emitting diodes 13 electrically connected to the circuit board 12 can be disposed on the circuit board 12 by surface mount technology.

The light transmissive shell 14 disposed on the side of the circuit board 12 can be made of acrylate, plastic or glass.

The cover 15 pivotally connected to the rotating shaft 1111 and disposed on one side of the circuit board 12 can be made of stainless steel. Besides, a plurality of grooves 141 are provided on the inner side of the cover 15. The width of the grooves 141 are corresponding to the width of the collar 16.

The collar 16 inserted into the grooves 141 for contacting against the cover 15 can be made of stainless steel, so as to combine the cover 15 and the wheel rim 21 with each other tightly.

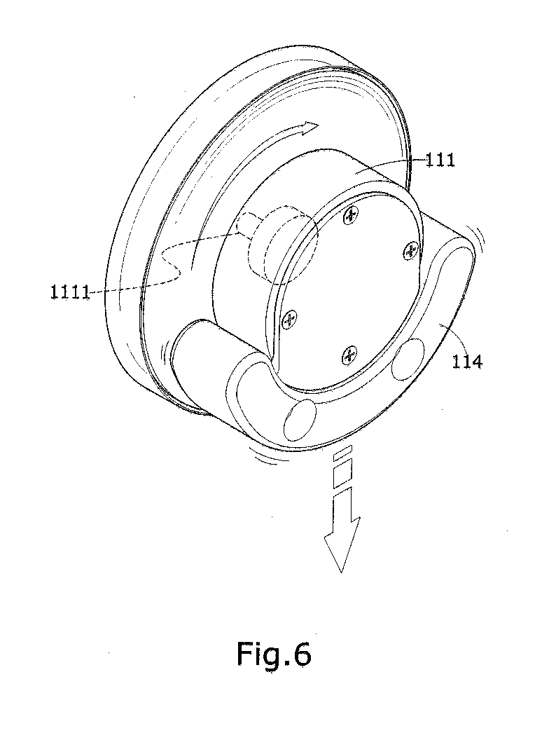

As the driver starts the engine, the cover 15 starts to rotate with the wheel rim 21. When the cover 15 rotates, the rotating shaft 111 pivotally connected to the cover 15 will begin to rotate, also. When the vehicle moves, owing to the counterweight block 114 disposed within the housing 1112, the housing 1112 will not rotate with the wheel rim 21 and stay at original position, thus the rotor connected to the rotating shaft 111 rotates relatively with the stator mounted on inner side of the housing 1111, and generate power by electromagnetic induction effect to actuate the light emitting diodes 13 to emit twinkling lights, as shown in FIGS. 5, 6.

In summarization of the foregoing description, the effect of the wheel rim decorative lamp according to the present invention is that the decorative lamp can emit light automatically when the driver drives at night, thus improves safety and provides aesthetic feeling.

The another effect of the wheel rim decorative lamp according to the present invention o is that the collar can be directly inserted into the inner side of the cover, so as to contact against the cover for tightly mounting the lamp to the wheel rim, therefore facilitate the assembling process.

What are described above are only preferred embodiments of the invention and should not be used to limit the scope of the present invention, and therefore all equivalent changes and modifications, which do not depart from the spirit and scope of the present invention should be included in the appended claims.

In summarization of the foregoing description, the present invention meets the requirements of inventiveness and industrial applicability of patents, and the application for a utility model patent is duly filed accordingly.

What is claimed is:

1. A wheel rim decorative lamp for mounting on the wheel rim of a vehicle, comprising:
a motor assembly, including:
a motor, having:
a rotating shaft; and
a housing, disposed on the outer side of the rotating shaft;
a counterweight block, disposed on the outer side of the motor;
a circuit board, disposed on one side of the motor assembly;
a plurality of light emitting diodes, disposed on one side of the circuit board;
a light transmissive shell, disposed on one side of the circuit board; and
a cover, disposed on one side of the circuit board, and the cover being pivotally connected to the rotating shaft, wherein the cover drives the rotating shaft to rotate relatively with the housing, thus generate electricity to actuate the light emitting diodes to emit lights.

2. The wheel rim decorative lamp as described in claim 1, further comprising:
a collar, disposed on the inner side of the cover for contacting against the cover.

3. The wheel rim decorative lamp as described in claim 1, wherein the motor assembly further comprises a first plate and a second plate, the first plate is disposed on one side of the motor, the second plate is disposed on the other side of the motor, and the counterweight block is disposed on one side of the second plate.

4. The wheel rim decorative lamp as described in claim 1, further comprising a plurality of grooves provided on the inner side of the cover, and the collar being inserted into the grooves.

5. The wheel rim decorative lamp as described in claim 3, further comprising a plurality of grooves are provided on the inner side of the cover, and the collar being inserted into the grooves.

6. The wheel rim decorative lamp as described in claim 2, wherein the motor assembly further comprises a first plate and a second plate, the first plate is disposed on one side of the motor, the second plate is disposed on the other side of the motor, and the counterweight block is disposed on one side of the second plate.

7. The wheel rim decorative lamp as described in claim 2, further comprising a plurality of grooves provided on the inner side of the cover, and the collar being inserted into the grooves.

8. The wheel rim decorative lamp as described in claim 6, further comprising a plurality of grooves are provided on the inner side of the cover, and the collar being inserted into the grooves.
